(19) United States
(12) Patent Application Publication
(10) Pub. No.: US 2026/0185952 A1
(43) Pub. Date: Jul. 2, 2026

(54) APPARATUS AND METHOD FOR MEASURING CURIE TEMPERATURE OF MAGNETIC MATERIAL

(71) Applicant: MAX PLANCK POSTECH/KOREA RESEARCH INITIATIVE, Pohang-si (KR)

(72) Inventors: Jae Hoon PARK, Pohang-si (KR); Choong Jae WON, Pohang-si (KR)

(73) Assignee: MAX PLANCK POSTECH/KOREA RESEARCH INITIATIVE, Pohang-si (KR)

(21) Appl. No.: 19/127,407

(22) PCT Filed: Oct. 6, 2023
(86) PCT No.: PCT/KR2023/014507

§ 371 Date: May 5, 2025

(30) Foreign Application Priority Data
Nov. 16, 2022 (KR) 10-2022-0153624
Jul. 11, 2023 (KR) 10-2023-0089605

(51) Int. Cl. G01N 25/12; G01K 7/02

(52) U.S. Cl. CPC G01N 25/12; G01K 7/02

(57) ABSTRACT

Disclosed is an apparatus for measuring a Curie temperature of a magnetic material. The apparatus includes: a reference magnet; a scale configured to measure a weight of the reference magnet; a measurement probe configured to mount a target magnetic material for measuring a Curie temperature at a position spaced apart from the reference magnet by a predetermined distance; a heater to change a temperature of the target magnetic material; and a thermometer to measure the temperature of the target magnetic material.

### TECHNICAL FIELD

The present disclosure relates to a measurement technique, and more specifically, to an apparatus and method for measuring a Curie temperature of a magnetic material.

The present disclosure has been derived from research conducted as part of the Nanomaterial Technology Development project, with Project ID: 1711158472, Project Number: 2020M3H4A2084418, Ministry: Ministry of Science and ICT; Project Management Agency: National Research Foundation of Korea; Research Program Title: Nanomaterial Technology Development; Research Project Title: Development of Advanced Composite Magnetic Material Design to Replace Scarce Resources; Contribution Rate: 1/1; Performing Institution: Max Planck POSTECH/Korea Research Initiative; and Research Duration: Jan. 1, 2022 to Dec. 31, 2022.

### BACKGROUND

In general, the Curie temperature of a ferromagnetic material and/or a ferrimagnetic material at room temperature or above may be measured using a Vibrating Sample Magnetometer. For example, it is possible to measure the temperature of a ferromagnetic material and/or a ferrimagnetic material using an induced electromotive force generated by vibrating a measurement sample at a specific frequency while applying a magnetic field using an electromagnet. Alternatively, the measurement of a Curie temperature may be conducted using a Superconducting Quantum Interference Device to measure magnetic properties by exploiting the quantum phenomena that occur in a Josephson junction device made of superconducting materials.

Among these conventional technologies, Superconducting Quantum Interference Device is capable of measuring very small magnetic fields. However, because the superconductivity phenomenon is utilized, achieving extremely low temperatures is required, which not only incurs costs for maintaining low temperatures but also creates a temperature difference between the measurement sample and the device. Thus, the Superconducting Quantum Interference Device is not suitable for measuring temperatures higher than room temperature when determining the Curie temperature of permanent magnets. In addition, in the case of a Vibrating Sample Magnetometer, although measurement at high temperatures is possible, a motor for vibrating a sample and an electromagnet for generating and measuring a magnetic field are essential, so there is a disadvantage in that it is not easy to prepare a measurement apparatus in terms of cost and space.

### SUMMARY

The present disclosure provides an apparatus for measuring a Curie temperature of a magnetic material, which measures the Curie temperature by utilizing a change in weight of a reference magnet according to a magnetic force between the reference magnet and a target magnetic material, thereby enabling replacement of conventional Curie temperature measurement apparatuses with a lower-cost and simplified configuration.

The present disclosure also provides a method for measuring a Curie temperature of a magnetic material, which measures the Curie temperature by utilizing a change in weight of a reference magnet according to a magnetic force between the reference magnet and a target magnetic material, thereby enabling replacement of conventional Curie temperature measurement apparatuses with a lower-cost and simplified configuration.

However, the objects to be achieved by the present disclosure are not limited thereto, and may be expanded in various ways without departing from the spirit and scope of the present disclosure.

In one aspect of the present disclosure, an apparatus for measuring a Curie temperature of a magnetic material may include: a reference magnet; a scale configured to measure a weight of the reference magnet; a measurement probe configured to mount a target magnetic material for measuring a Curie temperature at a position spaced apart from the reference magnet by a predetermined distance; a heater configured to change a temperature of the target magnetic material; and a thermometer configured to measure the temperature of the target magnetic material.

According to an aspect, the apparatus for measuring a Curie temperature may determine that a temperature of the target magnetic material at a point in time when a measured value of the weight of the reference magnet measured by the scale reaches a predetermined threshold is a Curie temperature of the target magnetic material.

According to an aspect, the target magnetic material may be mounted on the reference magnet.

According to an aspect, the predetermined threshold for the measured value of the weight of the reference magnet may be a measured value indicating that a magnetic force between the reference magnet and the target magnetic material is 0.

According to an aspect, the predetermined threshold for the measured value of the weight of the reference magnet may be a measured value indicating an inherent weight of the reference magnet in a state where the target magnetic material is not present.

According to an aspect, the measurement probe may be configured to inhibit generation of a magnetic force on the measurement probe and uniformly maintain a temperature of the measurement probe.

According to an aspect, the measurement probe may be formed of a non-magnetic metal.

According to an aspect, the heater may be an electric resistance heater.

According to an aspect, the thermometer may be configured to measure the temperature of the target magnetic material using a thermocouple.

According to an aspect, the apparatus may further include a thermal barrier disposed between the reference magnet and the measurement probe to block heat transfer.

According to an aspect, the thermal barrier may be a Au-coated quartz glass plate.

According to an aspect, the reference magnet may be placed on a non-magnetic material mounted on the scale, and the non-magnetic material may be configured to block influence of magnetic properties of the reference magnet on the scale.

In another aspect of the present disclosure, a magnetic measurement apparatus for measuring a magnetic force of a magnetic material may include: a reference magnet; a scale configured to measure a weight of the reference magnet; and a measurement probe configured to mount a target magnetic material for measuring magnetic properties at a position spaced apart from the reference magnet by a predetermined distance.

According to an aspect, the magnetic measurement apparatus may measure a magnetic force between the reference magnet and the target magnetic material based on a measured value of the weight of the reference magnet measured by the scale.

In yet another aspect of the present disclosure, a method for measuring a Curie temperature of a magnetic material may include: mounting a target magnetic material for measuring a Curie temperature at a position spaced apart from a reference magnet by a predetermined distance; increasing a temperature of the target magnetic material using a heater; and measuring the temperature of the target magnetic material at a point in time when a measured value of a weight of the reference magnet reaches a predetermined threshold.

According to an aspect, the method may further include determining that the temperature of the target magnetic material at a point in time when the measured value of the weight of the reference magnet reaches the predetermined threshold is a Curie temperature of the target magnetic material.

In yet another aspect of the present disclosure, a method for measuring magnetic properties of a magnetic material may include: mounting a target magnetic material at a position spaced apart from a reference magnet by a predetermined distance; and determining a measured value of a magnetic force between the reference magnet and the target magnetic material based on a measured value of a weight of the reference magnet.

The disclosed technology may have the following effects. However, it should not be construed that the scope of the disclosed technology is limited thereby, as it does not mean that a specific embodiment must include all or only the following effects.

According to the apparatus and method for measuring a Curie temperature of a magnetic material according to one embodiment of the present disclosure described above, the Curie temperature is measured by utilizing a change in weight of the reference magnet depending on the magnetic force between a reference magnet and a target magnetic material, thereby replacing conventional apparatuses for measuring a Curie temperature with a lower price and simpler configuration.

More specifically, though not exclusively, the Curie temperature, which is the temperature at which a permanent magnet becomes magnetized, may be precisely measured using a magnetic force between a permanent magnet and a sample. Accordingly, the apparatus and method for measuring a Curie temperature of a magnetic material may be applied to a procedure of verifying performance of a permanent magnet that is an essential and core component in advanced industrial fields. The apparatus and method may replace existing high-temperature magnetization rate measurement methods, which are vibrating sample magnetic measurement methods, with a low price and simplified method, and thus, the apparatus and method may be used as a product for measuring a Curie temperature of a permanent magnet may partially replace high-temperature magnetic measurement apparatuses currently in use.

### BRIEF DESCRIPTION OF THE DRAWINGS

FIG. 1 is a block diagram showing the configuration of an apparatus for measuring a Curie temperature of a magnetic material according to one embodiment of the present disclosure.

FIG. 2 is an exemplary configuration diagram for the apparatus for measuring a Curie temperature of FIG. 1.

FIG. 3 is a schematic flowchart of a method for measuring a Curie temperature of a magnetic material according to one embodiment of the present disclosure.

FIG. 4 is a block diagram showing the configuration of a magnetic measurement apparatus for measuring a magnetic force of a magnetic material according to one embodiment of the present disclosure.

FIG. 5 is a schematic flowchart of a magnetic measurement method according to one embodiment of the present disclosure.

FIG. 6 shows an example implementation of the apparatus for measuring a Curie temperature of FIG. 1.

FIG. 7 shows the measurement results of temperature-weight changes for multiple permanent magnet samples measured using an apparatus for measuring a Curie temperature according to one embodiment of the present disclosure.

### DETAILED DESCRIPTION

The present disclosure may be modified in various ways and may have various embodiments. Specific embodiments will be illustrated in the drawings and described in detail.

It is, however, to be understood that the present disclosure is not intended to be limited to the specific embodiments, but includes all modifications, equivalents and/or substitutions which fall within the spirit and technological scope of the present disclosure.

It will be understood that, although the terms first, second, third, etc. may be used herein to describe various elements, these elements should not be limited by these terms. These terms are generally only used to distinguish one component from another. For example, a first component may be referred to as a second component without departing from the scope of the present disclosure, and likewise a second component may be referred to as a first component. As used herein, the term “and/or” includes any and all combinations of one or more of the associated listed items.

It will be understood that when a component is referred to as being “connected with” another component, the component may be connected with the other component or intervening components may also be present. In contrast, when a component is referred to as being “directly connected with” another component, there are no intervening components present.

The terminology used herein is for the purpose of describing particular embodiments only and is not intended to be limiting. As used herein, the singular forms “a”, “an,” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, with reference to the accompanying drawings, an embodiment of the present disclosure will be described in more detail. To facilitate the entire understanding of the present disclosure, the same reference numerals in the drawings denote the same elements, and repetitive description of the same elements is omitted.

As previously discussed, the measurement of the Curie temperature of a magnetic material at room temperature or above has been conducted using a Vibrating Sample Magnetometer or a Superconducting Quantum Interference Device. However, the Superconducting Quantum Interference Device not only incurs costs for maintaining low temperatures, but is also not suitable for measuring temperatures higher than room temperature, while the Vibrating Sample Magnetometer poses challenges in terms of cost and space requirements, making it difficult to implement as a measurement apparatus.

The invention according to the present disclosure is intended to solve such problems, and by measuring a Curie temperature based on a change in weight of a reference magnet according to a magnetic force between the reference magnet and a target magnetic material, the apparatus for measuring a Curie temperature of the magnetic material according to the embodiments of the present disclosure may replace the conventional apparatuses for measuring a Curie temperature with a lower price and simpler configuration.

The measurement method according to the present disclosure may be implemented, for example, by an apparatus and method for measuring a Curie temperature of a magnetic material using magnetic force at room temperature or higher, but is not limited thereto. For example, the apparatus and method may be utilized in the research fields related to magnetic materials, especially in the field of Curie temperature and magnetic force measurement for evaluating the performance of permanent magnets, and may be implemented as a device for measuring permanent magnet characteristics, a research device for magnetic materials at room temperature or above, a magnetism-related research device for basic science research laboratories, etc. Furthermore, the apparatus and method are expected to be utilized across industries for research on permanent magnet production and performance improvement, and across research fields related to magnetic material performance research experiments.

The apparatus for measuring a Curie temperature according to one aspect of the present disclosure may utilize a magnetic force between magnets to measure a Curie temperature at a high temperature at room temperature or above. Therefore, it is possible to measure a Curie temperature of a permanent magnet at high temperatures. For example, a target magnetic material is placed at a predetermined distance from a fixed reference magnet, and a magnetic force between a reference magnet and a target magnetic material is varied by changing a temperature of the target magnetic material, and a change in weight of the reference magnet due to the change in magnetic force between the reference magnet and the target magnetic material may be measured. In this case, a temperature at which the magnetic force becomes 0 may be determined to be the Curie temperature of the target magnetic material.

### Apparatus for Measuring Curie Temperature

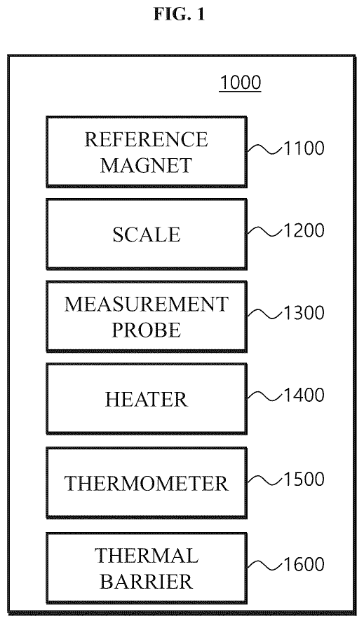

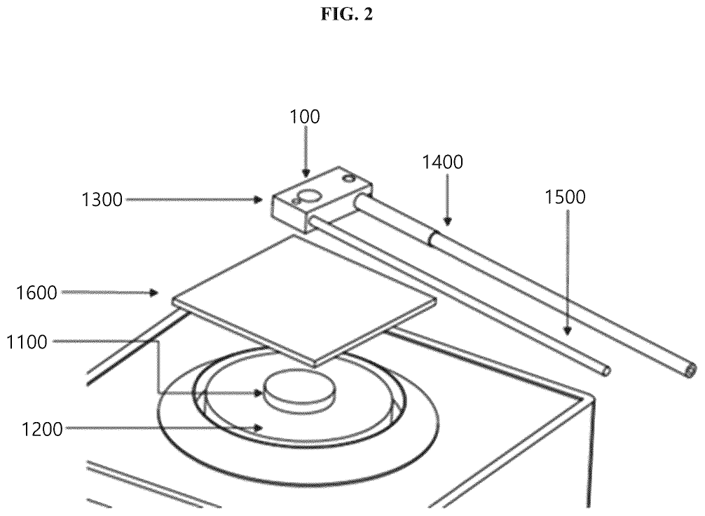

FIG. 1 is a block diagram showing the configuration of an apparatus for measuring a Curie temperature of a magnetic material according to one embodiment of the present disclosure, and FIG. 2 is an exemplary configuration diagram of the apparatus for measuring a Curie temperature of FIG. 1. Hereinafter, the apparatus for measuring a Curie temperature of a magnetic material according to one embodiment of the present disclosure will be described in more detail with reference to FIGS. 1 and 2.

As illustrated in FIGS. 1 and 2, an apparatus 1000 for measuring a Curie temperature of a magnetic material according to one embodiment of the present disclosure may include at least one of a reference magnet 1100, a scale 1200, a measurement probe 1300, a heater 1400, a thermometer 1500, or a thermal barrier 1600.

More specifically, though not exclusively, as illustrated in FIGS. 1 and 2, the apparatus 1000 for measuring a Curie temperature of a magnetic material may include the reference magnet 1100 and the scale 1200 configured to measure a weight of the reference magnet.

The measurement probe 1300 may be configured to mount a target magnetic material 100 for measuring a Curie temperature at a position spaced apart by a predetermined distance from the reference magnet 1100. According to one aspect, the target magnetic material 100 may be mounted on the reference magnet 1100 using the measurement probe 1300, but is not limited thereto.

Here, for example, the heater 1400 and/or the thermometer 1500 may be provided in the measurement probe 1300, but is not limited thereto. The heater 1400 may be a configuration for changing the temperature of the target magnetic material 100, and the thermometer 1500 may be a configuration for measuring the temperature of the target magnetic material 100.

According to one aspect, the apparatus 1000 for measuring a Curie temperature of a magnetic material may determine that a temperature of the target magnetic material 100 at a point in time when a measured value of the weight of the reference magnet 1100 measured by the scale 1200 reaches a predetermined threshold is the Curie temperature of the target magnetic material 100.

For example, by gradually increasing the temperature of the target magnetic material 100 using the heater 1400, the magnetic properties of the target magnetic material 100 may change in response to a temperature change. When the magnetic properties of the target magnetic material 100 changes, the magnitude of the magnetic force acting between the reference magnet 1100 and the target magnetic material 100 also changes, and therefore, the weight of the reference magnet 1100 measured by the scale 1200 also changes.

Based on the above, according to one aspect, a predetermined threshold for a measured value of the weight of the reference magnet 1100 measured by the scale 1200 serves as a reference for the point in time at which the temperature of the target magnetic material 100 is measured to determine a Curie temperature of the target magnetic material 100, and the predetermined threshold for the measured value of the weight of the reference magnet 1100 measured by the scale 1200 may be a measured value indicating that the magnetic force between the reference magnet 1100 and the target magnetic material 100 is 0. That is, by gradually increasing the temperature of the target magnetic material 100, the temperature of the target magnetic material 100 at a point in time when the magnetic force between the reference magnet 1100 and the target magnetic material 100 reaches 0 may be determined as the Curie temperature of the target magnetic material 100.

More specifically, though not exclusively, a predetermined threshold for a measured value of the weight of the reference magnet 1100, measured by the scale 1200 and serving as a reference for a point in time when a temperature of the target magnetic material 100 is measured to determine the Curie temperature of the target magnetic material 100, may be a measured value indicating an inherent weight of the reference magnet 1100 in a state where the target magnetic material 100 is not present. For example, at a point in time when the target magnetic material 100 is not placed on the measurement probe 1300, a weight of the reference magnet 1100 measured by the scale 1200 may be a first measured value. Here, when the target magnetic material 100 is placed on the measurement probe 1300, the weight of the reference magnet 1100 measured by the scale 1200 may be increased or decreased. Thereafter, the temperature of the target magnetic material 100 is gradually increased using the heater 1400, and at a point in time when the weight of the reference magnet 1100, which varies due to the mounting of the target magnetic material 100, returns to the weight of the reference magnet 1100 measured prior to the mounting of the target magnetic material 100, the temperature of the target magnetic material 100 may be measured and determined as the Curie temperature of the target magnetic material 100.

In other words, a method for measuring a Curie temperature according to one embodiment of the present disclosure may utilize a phenomenon in which the target magnetic material 100 loses magnetization at or above the Curie temperature to generate no magnetic force by measuring the magnetic force between the reference magnet 1100 and the target magnetic material 100 using a laboratory electronic scale 1200. Here, the force between the reference magnet 1100 and the target magnetic material 100 may be simply described in the case of simple magnetic poles. However, when applied in practice, if the reference magnet 1100 or the target magnetic material 100 has a specific shape, describing the force therebetween may be highly complex and difficult.

In the configuration of the apparatus 1000 according to one aspect of the present disclosure, it is obvious that when the magnetic properties of the target magnetic material 100 changes, the magnetic force between the reference magnet 1100 and the target magnetic material 100 changes. Here, in the case of measuring the weight of the reference magnet 1100, the weight of the magnet is measured as the actual weight of the magnet plus the force exerted by the magnetic force. For example, in the case of two magnets with a magnetic force acting therebetween, when the magnitude of the magnetic properties of the target magnetic material 100 is changed in response to a temperature change, the magnetic force between the two magnets also changes.

At this point, when measuring a weight of the reference magnet 1100, as the magnetic force changes, the measured weight of the reference magnet 1100 changes by the force caused by the changed magnetic force. For example, when a magnetic force is acting on the two magnets and the temperature of the target magnetic material 100 reaches the Curie temperature at which magnetism disappears, the magnetic force between the two magnets becomes 0. At this point, in the case of measuring the weight of the reference magnet 1100, only the inherent weight of the reference magnet 1100 is measured as the magnetic force reaches 0. Therefore, it may be determined that a temperature at which only the inherent weight of the reference magnet 1100 is measured is a temperature at which the magnetic force acting between the two magnets becomes 0. Next, the temperature of the target magnetic material 100 at a point of time when the magnetic force acting between the two magnets becomes 0 may be determined as a Curie temperature at which the magnetism of the target magnetic material 100 disappears. According to the above, the apparatus 1000 for measuring a Curie temperature according to one aspect of the present disclosure may determine the magnetic force acting between the reference magnet 1100 and the target magnetic material 100 by measuring the weight of the reference magnet 1100.

As shown in FIG. 2, the measurement probe 1300 and the reference magnet 1100 are positioned at a predetermined distance apart so that a change in the weight of the reference magnet 1100, caused by a change in the magnetic force of the target magnetic material 100 due to a temperature change, may be measured, and the reference magnet 1100 is disposed on the scale 1200. As previously discussed, the measurement probe 1300 may be equipped with the heater 1400 and the thermometer 1500. According to one aspect, the heater 1400 may be an electric resistance heater, and the thermometer 1500 may be configured to measure a temperature of the target magnetic material using a thermocouple, but is not limited thereto.

According to one aspect, the measurement probe 1300 may be configured so that the generation of a magnetic force on the measurement probe itself is inhibited while the temperature of the measurement probe is maintained uniformly. For example, though not exclusively, the measurement probe may be formed of a non-magnetic metal. That is, for example, by using a non-magnetic metal, it is possible to eliminate any magnetic force that may be generated by the measurement probe 1300, while maintaining a uniform temperature of the probe.

According to one aspect, the temperature of the target magnetic material 100 may be controlled by heating the probe using the heater 1400, such as an electric resistance heater, to change the temperature of the target magnetic material 100. At this point, a temperature difference between the measured temperature and the actual temperature of the target magnetic material 100 may be reduced as much as possible by checking a temperature through a thermocouple 1500 connected to the probe.

As shown in FIGS. 1 and 2, the measurement probe 1300 may be positioned at a predetermined distance so as not to come into contact with the reference magnet 1100 placed on the electronic scale 1200. According to one aspect, the apparatus 1000 for measuring a Curie temperature of a magnetic material may further include the thermal barrier 1600 disposed between the reference magnet 1100 and the measurement probe 1300 to block heat transfer. For example, the thermal barrier 1600 may be, but is not limited to, an Au-coated quartz glass plate.

More specifically, for example, a quartz glass plate 1600 coated with Au to block heat may be positioned between the reference magnet 1100 and the measurement probe 1300 so that the reference magnet 1100 is not affected by heating of the measurement probe 1300. According to one aspect, by placing a non-magnetic material on a scale and positioning the reference magnet 1100 thereon, the reference magnet 1100 is positioned at a specific location on the scale 1200 to measure the entire weight of the reference magnet 1100, thereby preventing the scale 1200 from being affected by the magnetism of the reference magnet 1100 during weight measurement. That is, for example, the reference magnet 1100 is placed on top of a non-magnetic material mounted on the scale 1200, and the non-magnetic material may be configured to block the influence of the magnetism of the reference magnet 1100 on the scale 1200.

When magnetism is present in the target magnetic material 100, the weight of the reference magnet 1100 changes depending on a magnitude of a magnetic force occurring between the reference magnet 1100 and the target magnetic material 100. At this point, the presence of the magnetic force may be determined because the magnetic force affects the measurement of the weight of the reference magnet 1100. For example, when an attractive force acts between two magnets, the stronger the magnetism of the target magnetic material 100, the stronger the attractive force with the reference magnet 1100. As a result, the measured weight of the reference magnet 1100 is determined as the inherent weight of the reference magnet 1100 minus the magnetic force with the target magnetic material 100. Therefore, the measured weight of the reference magnet 1100 may be smaller compared to the case where no magnetic force is present. As the temperature of the target magnetic material 100 approaches the Curie temperature, the magnetic force weakens, so the weight of the reference magnet 1100 may gradually approach the weight of the actual reference magnet 1100. For example, if the magnetism of the target magnetic material 100 disappears, the magnetic force between the reference magnet 1100 and a sample becomes 0, and the change in the weight of the reference magnet 1100 disappears. At this point, the measured weight of the reference magnet 1100 is the same as the actual weight of the reference magnet 1100 when no magnetic force acts, and thus, the temperature of the target magnetic material 100 at this point may be determined as a Curie temperature of the target magnetic material 100.

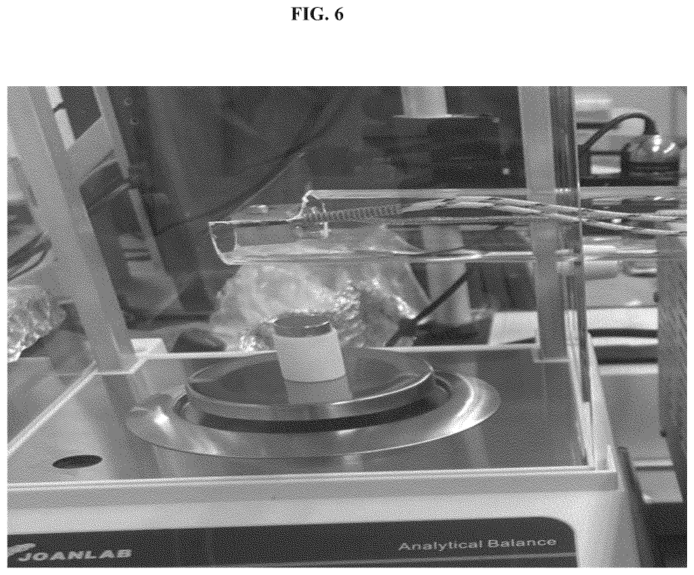

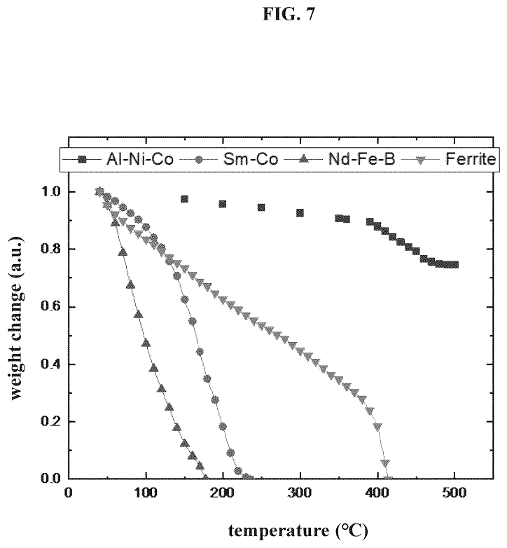

By using the functions of the present disclosure configured as described above, a Curie temperature at which magnetism of a permanent magnet is generated at room temperature or above may be determined. FIG. 6 shows an example implementation of the apparatus for measuring a Curie temperature of FIG. 1. FIG. 7 shows the measurement results of temperature-weight changes for multiple permanent magnet samples measured using an apparatus for measuring a Curie temperature according to one embodiment of the present disclosure. As illustrated in FIG. 7, according to procedures for measuring a Curie temperature of a magnetic material at high temperatures using a magnetic force according to one embodiment of the present disclosure, a change in weight of a reference magnet 1100 due to a temperature change of a commercially available permanent magnet sample is measured. A temperature of the permanent magnet sample is increased up to 500° C. while a change in weight of the reference magnet 1100 is measured. As shown in FIG. 7, the Curie temperature is confirmed to be 179° C. for neodymium magnets, 241° C. for samarium cobalt magnets, 415° C. for ferrite magnets, and 500° C. or above for the alnico magnets.

As such, according to an apparatus for measuring a Curie temperature of a magnetic material according to one aspect of the present disclosure, a Curie temperature at which a target magnetic material 100 is magnetized may be precisely measured using a magnetic force between a reference magnet and the target magnetic material. Accordingly, the apparatus for measuring a Curie temperature of a magnetic material may be applied to verify the performance of permanent magnets, which are essential and core components in advanced industrial fields. It is possible to replace a Vibrating Sample Magnetometer method, which is a conventional high-temperature magnetization rate measurement method, with a low-price and simplified method, and thus, the apparatus for measuring a Curie temperature of a magnetic material according to the present disclosure may be used as a product for measuring a Curie temperature of a permanent magnet and may partially replace high-temperature magnetic measurement apparatuses currently in use.

### Method for Measuring a Curie Temperature

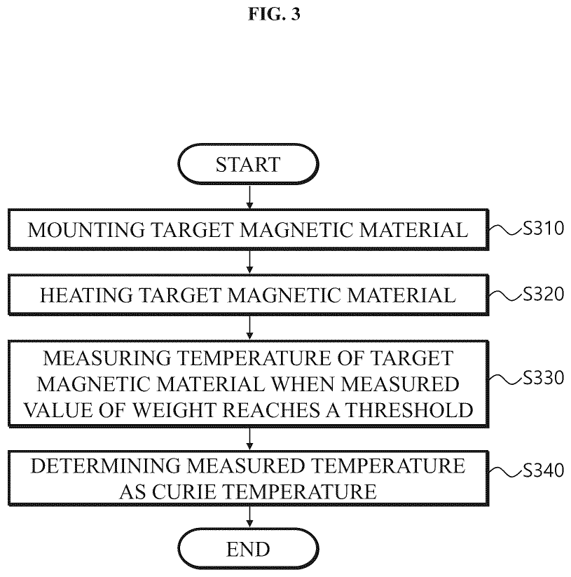

FIG. 3 is a schematic flowchart of a method for measuring a Curie temperature of a magnetic material according to one embodiment of the present disclosure. As illustrated in FIG. 3, a method for measuring a Curie temperature of a magnetic material according to one embodiment of the present disclosure may include: mounting a target magnetic material (step 310); heating the target magnetic material (step 320); measuring a temperature of the target magnetic material when a measured value of weight reaches a threshold (step 330); and determining the measured temperature as a Curie temperature (step 340). Hereinafter, a more detailed explanation is provided with reference to FIG. 3.

According to a method for measuring a Curie temperature of a magnetic material according to one embodiment of the present disclosure, a target magnetic material 100 for measuring a Curie temperature may be mounted at a position spaced apart from a reference magnet 1100 by a predetermined distance in step 310. Thereafter, a temperature of the target magnetic material 100 is increased using the heater 1400 in step 320, and the temperature of the target magnetic material 100 at a point in time when a measured value of the weight of a reference magnet 1100 reaches a predetermined threshold may be measured in step 330. In this case, the temperature of the target magnetic material 100 at the point in time when a measured value of the weight of the reference magnet 1100 reaches the predetermined threshold may be determined as a Curie temperature of the target magnetic material 100 in step 340.

More specific procedures of the method for measuring a Curie temperature of a magnetic material according to one embodiment of the present disclosure may at least partially adopt the operations of the apparatus for measuring a Curie temperature of a magnetic material according to one embodiment of the present disclosure described above.

### Magnetic Measurement Apparatus and Method

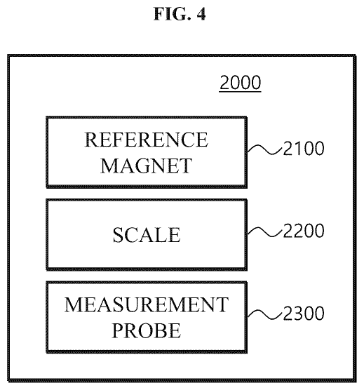

FIG. 4 is a block diagram showing the configuration of a magnetic measurement apparatus for measuring a magnetic force of a magnetic material according to one embodiment of the present disclosure. Hereinafter, with reference to FIG. 4, a magnetic measurement apparatus 2000 according to one embodiment of the present disclosure will be described in more detail.

As illustrated in FIG. 4, a magnetic measurement apparatus 2000 according to one embodiment of the present disclosure may include a reference magnet 2100, a scale 2200, and a measurement probe 2300. More specifically, though not exclusively, as illustrated in FIG. 4, the magnetometry apparatus 2000 may include the reference magnet 2100 and the scale 2200 configured to measure a weight of the reference magnet.

The measurement probe 2300 may be configured to mount a target magnetic material for measuring magnetic properties at a position spaced apart from the reference magnet 2100 by a predetermined distance. According to one aspect, the target magnetic material may be mounted on the reference magnet 2100 using the measurement probe 2300, but is not limited thereto.

According to one aspect, the magnetic measurement apparatus 2000 may be configured to measure a magnetic force between the reference magnet 2100 and the target magnetic material based on a measured value of the weight of the reference magnet 2100 measured by the scale 2200. As previously described regarding the apparatus for measuring a Curie temperature according to one embodiment of the present disclosure, a magnitude of the magnetic force acting between the reference magnet 2100 and the target magnetic material may be determined depending on the magnetic properties of the target magnetic material. Accordingly, the weight of the reference magnet 2100 measured by the scale 2200 may also be determined differently depending on the magnetic properties of a specific target magnetic material.

Accordingly, by using the inherent weight of the reference magnet 2100 as a reference value when the target magnetic material is not mounted, the magnetic properties of the target magnetic material may be measured based on a degree to which the weight of the reference magnet 2100 changes from the reference value when the target magnetic material is mounted on the measurement probe 2300. A measured value of the magnetic properties of the target magnetic material based on the degree of change in the weight of the reference magnet may be determined using an experimental result measured for the magnitude of the magnetic properties and weight change value based on a predetermined sample specimen whose magnitude of the magnetic properties is known, but aspects of the present disclosure are not limited thereto.

Meanwhile, it should be understood that at least some of the configurations applied for measurement accuracy or convenience in the apparatus for measuring a Curie temperature according to one embodiment of the present disclosure, such as the non-magnetic property of a measurement probe or the arrangement of a reference magnet on a non-magnetic material placed on a scale, may also be equally applied to the magnetic measurement apparatus according to one embodiment of the present disclosure.

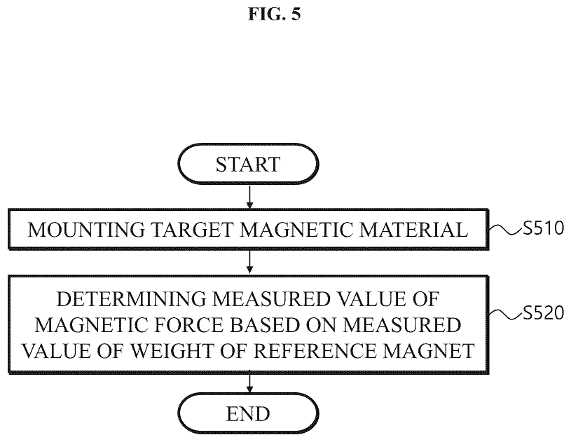

FIG. 5 is a schematic flowchart of a magnetic measurement method according to one embodiment of the present disclosure. As illustrated in FIG. 5, according to a magnetic measurement method according to one embodiment of the present disclosure, a target magnetic material is mounted at a position spaced apart from a reference magnet by a predetermined distance in step 510, and a measured value of a magnetic force between the reference magnet and the target magnetic material may be determined based on a measured value of the weight of the reference magnet in step 520. The magnetic properties of the target magnetic material may be determined using the measured value of the magnetic force between the reference magnet and the target magnetic material.

More specific procedures of the magnetic measurement method according to one embodiment of the present disclosure may at least partially adopt the operations of the above-described apparatus for measuring a Curie temperature of a magnetic material and/or the above-described magnetic measurement apparatus according to one embodiment of the present disclosure.

Although the present disclosure has been described with reference to the drawings and embodiments, it does not mean that the scope of protection of the present disclosure is limited by the drawings or embodiments, and it will be understood that a person skilled in the art may variously modify and change the present disclosure without departing from the spirit and scope of the present disclosure as described in the following claims.

While the present disclosure has been described on the basis of a series of functional blocks, it is not limited by the embodiments described above and the accompanying drawings, and it will be apparent to those skilled in the art that various substitutions, modifications and variations can be made without departing from the scope of the present disclosure.

The combination of the above-described embodiments is not limited to the above-described embodiments, and various forms of combination in addition to the above-described embodiments may be provided according to implementation and/or necessity.

In the above-described embodiments, methods have been described based on a flowchart as a series of steps or blocks, but the present disclosure is not limited to the order of steps, and some steps may be performed in a different order or simultaneously. Further, one of ordinary skill in the art would easily understand that steps in the flowchart are not exclusive, another step may be added, or one or more steps in the flowchart may be deleted without affecting the scope of the present disclosure.

The above-described embodiments include various forms of examples. It is not possible to describe all possible combinations for indicating various forms, but one of ordinary skill in the art would easily recognize the possibility of other combinations. Hence, it should be understood that the present disclosure includes all other substitutions, modifications, and changes within the scope of claims below.

1. An apparatus for measuring a Curie temperature of a magnetic material, comprising:
a reference magnet;
a scale configured to measure a weight of the reference magnet;
a measurement probe configured to mount a target magnetic material for measuring a Curie temperature at a position spaced apart from the reference magnet by a predetermined distance;
a heater to change a temperature of the target magnetic material; and
a thermometer to measure the temperature of the target magnetic material.

2. The apparatus of claim 1, wherein the apparatus determines that a temperature of the target magnetic material at a point in time when a measured value of the weight of the reference magnet measured by the scale reaches a predetermined threshold is a Curie temperature of the target magnetic material.

3. The apparatus of claim 1, wherein the target magnetic material is mounted on the reference magnet.

4. The apparatus of claim 1, wherein the predetermined threshold for the measured value of the weight of the reference magnet is a measured value indicating that a magnetic force between the reference magnet and the target magnetic material is 0.

5. The apparatus of claim 1, wherein the predetermined threshold for the measured value of the weight of the reference magnet is a measured value indicating an inherent weight of the reference magnet in a state where the target magnetic material is not present.

6. The apparatus of claim 1, wherein the measurement probe is configured to inhibit generation of a magnetic force on the measurement probe and uniformly maintain a temperature of the measurement probe.

7. The apparatus of claim 6, wherein the measurement probe is formed of a non-magnetic metal.

8. The apparatus of claim 1, wherein the heater is an electric resistance heater.

9. The apparatus of claim 1, wherein the thermometer is configured to measure the temperature of the target magnetic material using a thermocouple.

10. The apparatus of claim 1, further comprising:
a thermal barrier disposed between the reference magnet and the measurement probe to block heat transfer.

11. The apparatus of claim 10, wherein the thermal barrier is an Au-coated quartz glass plate.

12. The apparatus of claim 1, wherein the reference magnet is placed on a non-magnetic material mounted on the scale, and the non-magnetic material is configured to block influence of magnetic properties of the reference magnet on the scale.

13. A magnetic measurement apparatus for measuring a magnetic force of a magnetic material, comprising:
a reference magnet;
a scale configured to measure a weight of the reference magnet; and
a measurement probe configured to mount a target magnetic material for measuring magnetic properties at a position spaced apart from the reference magnet by a predetermined distance.

14. The magnetic measurement apparatus of claim 13, wherein the magnetic measurement apparatus measures a magnetic force between the reference magnet and the target magnetic material based on a measured value of the weight of the reference magnet measured by the scale.

15. A method for measuring a Curie temperature of a magnetic material, comprising:
mounting a target magnetic material for measuring a Curie temperature at a position spaced apart from a reference magnet by a predetermined distance;
increasing a temperature of the target magnetic material using a heater; and
measuring the temperature of the target magnetic material at a point in time when a measured value of a weight of the reference magnet reaches a predetermined threshold.

16. The method of claim 15, further comprising:
determining that the temperature of the target magnetic material at a point in time when the measured value of the weight of the reference magnet reaches the predetermined threshold is a Curie temperature of the target magnetic material.

17. A method for measuring magnetic properties of a magnetic material, comprising:
mounting a target magnetic material at a position spaced apart from a reference magnet by a predetermined distance; and
determining a measured value of a magnetic force between the reference magnet and the target magnetic material based on a measured value of a weight of the reference magnet.
